(19) United States
(12) Patent Application Publication
(10) Pub. No.: US 2008/0001329 A1
(43) Pub. Date: Jan. 3, 2008

(54) MOLDING SYSTEMS AND METHODS

(76) Inventors: EDWARD G. VANNIMWEGEN, North Ogden, UT (US); Richard Hendricksen, Uintah, UT (US); Bob Adams, Kaysville, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/771,378

(22) Filed: Jun. 29, 2007

Related U.S. Application Data
(60) Provisional application No. 60/817,834, filed on Jun. 29, 2006.

(51) Int. Cl. B29C 43/02; B29C 45/00

(52) U.S. Cl. 264/320; 264/328.1

(57) ABSTRACT

An exemplary molding method may include converting plastic wrap into moldable plastic, loading the plastic into a mold, and molding the plastic into a desired product. The method may also include cleaning and/or shredding the plastic wrap. An exemplary molding system may include a plasticizing apparatus and a mold. The plasticizing apparatus may be configured to convert plastic wrap into moldable plastic. The plastic may be loaded from the plasticizing apparatus to the mold, which may be used to mold the plastic into a desired product. The molding system may also include a cleaning apparatus and/or a shredding apparatus.

### CROSS-REFERENCE TO RELATED APPLICATIONS

This application claims priority to and the benefit of U.S. provisional patent application ser. No. 60/817,834, which was filed on Jun. 29, 2006 and entitled MOLDING SYSTEMS AND METHODS, the disclosure of which is incorporated by reference in its entirety.

### BACKGROUND OF THE INVENTION

1. Field of the Invention

The present invention generally relates to molding plastic and, in particular, to systems and methods for molding plastic into finished products.

2. Description of Related Art

Plastic wrap, such as stretch wrap or shrink wrap, may be used to aid in shipping and packaging various items. For example, plastic wrap may be used to help secure various products, boxes and/or other items to a pallet for shipment. In any given year, retail and warehouse stores may receive hundreds or thousands of such pallets. These stores may also receive other types of plastic packing materials, plastic packaging materials and other items constructed from plastic, such as plastic hangers.

### BRIEF SUMMARY OF EMBODIMENTS OF THE INVENTION

A need therefore exists for systems and methods that eliminate or diminish the disadvantages and problems described above.

One aspect is a system or method that may include using used plastic to directly create finished plastic products or components. For example, the system or method may include converting used plastic (such as used plastic wrap or shrink wrap) into moldable plastic, loading the plastic into a mold and molding the plastic into desired finished products or components. The used plastic is preferably plastic that has been used for its intended purpose and, instead of being discarded, is used to directly create new finished products or components. The new finished products or components are products or components that are ready to be used for their intended purposes, and are not merely intermediate products that have to be further processed or molded to create finished products or components.

Another aspect is a system or method of using used plastic to directly create new products or components via compression molding processes, such as, thermoplastic compression molding processes. The system or method may include loading plastic into the mold by pouring, dropping and/or otherwise placing a charge of plastic directly into the mold. The charge of plastic may be any suitable amount of plastic depending, for example, upon the size, shape and type of product or component to be molded. The plastic may then be molded into the desired finished products or components. It will be appreciated that the plastic may also be molded using other suitable processes and methods such as blow molding, injection molding, extrusion molding and the like.

Advantageously, the used plastic may be directly molded into any desired finished products or components, without forming or creating intermediate products and without requiring any intermediate steps or processes. This may allow, for example, used plastic to be directly molded into finished products such as panels, partitions and the like. The used plastic may also be directly molded into various parts and components, such as portions of a table (including table tops, feet, benches, leg clips, etc.), portions of a chair (including seats, backrests, armrests, etc.), portions of a basketball system (including backboards, bases, wheels, etc.), portions of an enclosure such as a shed (including walls, floors, roofs, doors, skylights, etc.), portions of a fence and the like.

If the used plastic is directly molded into finished products and components, then that may help avoid material degradation which may occur from creating intermediate products. For example, if the plastic is made into an intermediate product (such as pellets) before making the finished product, then the melting of the plastic multiple times may degrade the plastic and that may increase the cost of making the finished product addition, if pellets or other intermediate products do not have to be formed, then that may allow finished products to be more quickly manufactured. Thus, if the used plastic is directly molded into finished products and components, then one or more intermediate steps may be eliminated and the plastic may not be degraded by the intermediate steps.

Still another aspect is a method that may utilize used or scrap plastic, such as used plastic wrap or shrink wrap, and directly mold the scrap plastic into finished products or components. The scrap plastic may be polyethylene and the polyethylene may be molded into any desired finished products or components using various suitable processes. It will be appreciated that the scrap plastic may also consist of other types of plastic and it may include a combination of different types of plastics, such as polyethylene and another suitable type of plastic.

Yet another aspect is a method that may employ used or scrap plastic to directly create finished products or components. Significantly, this method may include only a few steps and may eliminate steps that were previously required. For example, the method may include collecting used or scrap plastic (such as used plastic wrap or stretch wrap), shredding the plastic, converting the shredded plastic into moldable plastic, loading the plastic into a mold and molding the plastic into a desired finished product. It will be appreciated that steps such as collecting and shredding the plastic may not be required. Additionally, while not required, shredding the plastic may advantageously facilitate the conversion of the plastic into moldable plastic.

Still yet another aspect is a method that may include steps such as cleaning used or scrap plastic, converting the plastic into moldable plastic, loading the plastic into a mold and molding the plastic into a desired product. Cleaning the plastic may advantageously help reduce the amount of impurities that may be present in the molded plastic. The plastic, however, does not have to be cleaned depending, for example, upon the type of finished product to be molded.

A further aspect is a method that may include steps such as cleaning used or scrap plastic, shredding the plastic, converting the plastic into moldable plastic, loading the plastic into a mold and molding the plastic into desired products. The plastic, however, does not have to be cleaned or shredded depending, for example, upon the type and/or desired characteristics of the finished products.

A still further aspect is a system that may include a plasticizing apparatus and a mold. The plasticizing apparatus may be configured to convert used or scrap plastic into moldable plastic. This may allow used or scrap plastic to be loaded into the plasticizing apparatus and then directly molded into a finished product. Advantageously, this may eliminate various intermediate steps such as creating an intermediate product such as pellets.

Another aspect is a system that may include a shredding apparatus, a plasticizing apparatus and a mold. The shredding apparatus may be configured to shred used or scrap plastic and the shredded plastic may be loaded directly into the plasticizing apparatus. The plasticizing apparatus may be sized and configured to convert the shredded plastic into moldable plastic. The moldable plastic may then be loaded directly into the mold, which may be used to mold the plastic into a desired product.

Still another aspect is a system that may include a cleaning apparatus, a plasticizing apparatus and a mold. The cleaning apparatus may be sized and configured to clean used or scrap plastic and the cleaned plastic may be loaded directly into the plasticizing apparatus. The plasticizing apparatus may be sized and configured to convert the plastic into moldable plastic and the moldable plastic may be directly loaded into the mold. The system preferably consecutively cleans, plasticizes and molds the plastic into the finished products or components. In addition, the steps are preferably performed in this order, which may help minimize the steps or processes required to transform the used plastic into new finished products or components. It will be understood, however, that these steps may be performed in any suitable order and not all of the steps are required.

Yet another aspect is a system that may include a cleaning apparatus, a shredding apparatus, a plasticizing apparatus and a mold. The cleaning apparatus may be sized and configured to clean used or scrap plastic and the cleaned plastic may be directly loaded into the shredding apparatus. The shredding apparatus may shred the cleaned plastic and the shredded plastic may be loaded into the plasticizing apparatus. The plasticizing apparatus may be sized and configured to convert the plastic into moldable plastic and the moldable plastic may be directly loaded into the mold. While this system may include sequentially cleaning, shredding, plasticizing and/or molding the plastic directly into finished products, it will be appreciated that the system may include other processes and apparatuses. Preferably, however, the plastic is directly molded into finished products and no intermediate products are created.

A further aspect is a method that may involve directly molding finished products from used or scrap plastic without creating intermediate products such as pellets. Previously, used or scrap plastic was converted into pellets and then the pellets were used to create finished products. This method, however, may eliminate the steps of creating intermediate products. For example, the method may involve collecting used or scrap plastic, such as plastic wrap, shrink wrap, hangers, packing materials, packaging materials and the like. The used or scrap plastic may be collected from one or more retailers, vendors, sellers, manufacturers, merchants, etc. This method may be particularly useful for large retailers, discount retailers, club stores, department stores and the like because these stores may generate large volumes of such used or scrap plastic. The used or scrap plastic may be sorted into different types and/or categories of plastic. In addition, the used or scrap plastic may be cleaned and/or shredded. The plastic may then be used to directly create finished products with the appropriate characteristics. Significantly, because one or more intermediate steps may be eliminated, this method may result in valuable time and cost savings.

These and other aspects, features and advantages of the present invention will become more fully apparent from the following detailed description of preferred embodiments and appended claims.

### BRIEF DESCRIPTION OF THE DRAWINGS

The appended drawings contain figures of preferred embodiments to further illustrate and clarify the above and other aspects, advantages and features of the present invention. It will be appreciated that these drawings depict only preferred embodiments of the invention and are not intended to limit its scope. The invention will be described and explained with additional specificity and detail through the use of the accompanying drawings in which:

FIG. 1 is a flowchart illustrating an exemplary molding process;

FIG. 2 is a block diagram illustrating an exemplary molding system;

FIG. 3 is a perspective view of exemplary table and benches that may be created using the molding systems and/or methods;

FIG. 4 is a lower perspective view of an exemplary table that may be created using the molding systems and/or methods;

FIG. 5 is a perspective view of a portion of the table shown in FIG. 4, illustrating an exemplary receiving member;

FIG. 6 is a perspective view of another portion of the table shown in FIG. 4, illustrating another exemplary receiving member;

FIG. 7 is a perspective view of yet another exemplary receiving member that may be created using the molding systems and/or methods;

FIG. 8 is a perspective view of an exemplary basketball system that may be created using the molding systems and/or methods;

FIG. 9 is an exploded view of an exemplary enclosure that may be created using the molding systems and/or methods;

FIG. 10 is a perspective view of an exemplary fence that may be created using the molding systems and/or methods;

FIG. 11 is a cross-sectional view of an exemplary mow strip and a portion of an exemplary fence that may be created using the molding systems and/or methods; and

FIG. 12 is a perspective view of an exemplary chair that may be created using the molding systems and/or methods.

### DETAILED DESCRIPTION OF PREFERRED EMBODIMENTS

The present invention is generally directed towards systems and methods for molding plastic into finished products and components. The principles of the present invention, however, are not limited to systems and methods for molding plastic into finished products and components. It will be understood that, in light of the present disclosure, the systems and methods disclosed herein can be successfully used in connection with other systems, processes, methods, components, apparatuses and the like.

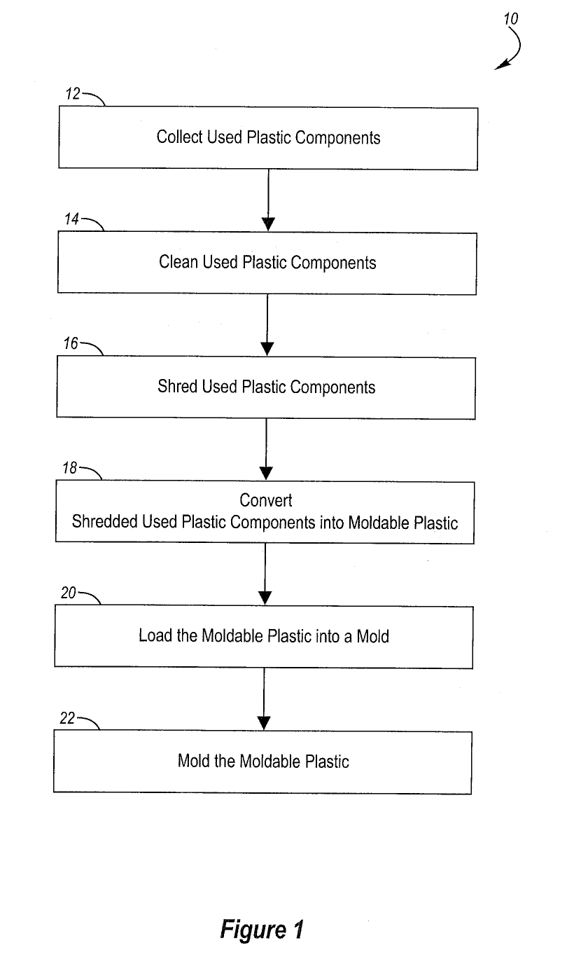

As shown in FIG. 1, an exemplary system and method 10 may be used to create molded plastic products and components by using used plastic components. As used herein, “used plastic components” refers to finished plastic products or finished plastic components that have been used for their intended purposes. That is, the plastic has previously been molded into a desired product or component and the product or component has been used for its intended purpose. For example, as discussed in greater detail below, the used plastic components may include plastic wrap or shrink wrap that was used in connection with transporting or storing one or more items. Thus, the used plastic components may be the plastic wrap used to secure items to a pallet for shipping and/or storage. The used plastic components may also be referred to as “scrap plastic,” but the scrap plastic has already been used for its intended purpose and is in condition to be discarded or recycled in a traditional manner. Scrap plastic, as used herein, is not intended to include excess plastic created or produced during the manufacturing process. In contrast, scrap plastic is used to refer to plastic that has been used for its intended purpose.

The system and/or method 10 may be particularly useful for large retailers, discount retailers, club stores, department stores and the like because these stores may generate large volumes of used plastic components for which they have little or no use—and thus is scrap plastic that is either discarded or recycled in a traditional manner. For example, these types of stores typically receive numerous items bundled or packaged together. Often times these numerous items are secured together by plastic wrap or shrink wrap. In addition, these numerous items are often transported and/or stored on pallets and the plastic wrap or shrink wrap may be used to secure the items to the pallets. After the items are received and/or stored, the plastic wrap or shrink wrap may be removed. The removed plastic has thus been used for its intended purposed and it now often discarded or recycled. The traditional recycling process typically involves creating intermediate products, such as pellets, which are then used to create finished products. The system and/or method 10, however, may eliminate the steps of creating the intermediate products such as pellets.

In greater detail, as shown at block 12, the used plastic components may be collected. The used plastic components may be collected, for example, from one or more retailers, vendors, sellers, manufacturers, merchants, etc. Exemplary used plastic components may include plastic wrap (such as stretch wrap or shrink wrap), plastic hangers that have been used to support clothing or other items, packing materials that have been used to help pack items, packaging materials that have been used to help package items and the like. Of course, the used plastic components may be collected from other sources and may include other used plastic components that have been used for their designed purposes.

As shown at block 14, the used plastic components may be cleaned. Cleaning the used plastic components may advantageously help reduce the amount of impurities that may be present in the molded plastic. The plastic may also be cleaned to help remove any foreign objects or materials. As shown at block 16, the used plastic components may be shredded and the shredded used plastic components may be converted into moldable plastic at block 18. As used herein, the term “moldable plastic” refers to plastic that is readily capable of being molded. That is, the moldable plastic may be capable of being directly placed in a mold and molded into the desired product or component.

Shredding the used plastic components may advantageously facilitate the conversion of the used plastic components into moldable plastic. It will be appreciated, however, that the used plastic components need not be shredded in order to be converted into moldable plastic. It will also be appreciated that the used plastic components do not have to be cleaned in order to be shredded or converted into moldable plastic. Thus, the system and/or method 10 does not require cleaning or shredding, but these steps may be performed, if desired. These and other steps, however, may be performed depending, for example, upon the particular implementation of the system and/or method 10.

If desired, as shown at block 18, heat and/or pressure may be applied to the used plastic components to convert the plastic into moldable plastic. In addition, one or more additives or other materials may be added to the used plastic components to help convert the used plastic components into moldable plastic. Of course, any suitable method may be used to convert the used plastic components into moldable plastic.

As shown at block 20, the moldable plastic may be loaded into a mold and, as shown at block 22, the plastic may be molded into a desired finished product or component. The plastic is preferably molded into the desired product via a compression molding process, such as, a thermoplastic compression molding process. In addition, the plastic may be loaded into a mold by pouring, dropping and/or otherwise placing a charge of plastic directly into the mold. It will be appreciated that the charge of plastic may be any suitable amount of plastic depending, for example, upon the product or component to be molded.

The compression molding process may advantageously be used in connection with the used plastic components. For example, the compression molding process may accommodate used plastic components constructed from a variety of different of plastics and plastics with different characteristics and properties. In addition, the compression molding process may facilitate a wide variety molding times, sizes of charges and it may be used to create finished products with a wide variety of different shapes, sizes, configurations and arrangements. It will be appreciated, however, that the plastic may be molded at block 20 using blow molding, injection molding, extrusion molding and/or other suitable molding processes.

In some instances, the used plastic components collected at the block 12 may include different types or categories of components and/or may be constructed from different types or characteristics of plastic. If desired, the used plastic components may be sorted and grouped according to, for example, the component type or category and/or the plastic type or characteristics. For example, plastic wrap may be separated from other items such as plastic packing materials, plastic packaging materials, plastic hangers and the like. In addition, the plastic may be sorted by the type of plastic such as linear low-density polyethylene may be separated from other types of plastic such as high density polyethylene, polystyrene, polypropylene and the like. It will be appreciated that the plastic may be sorted at any desired time, but the plastic does not have to be sorted.

If desired, the system and/or method 10 may use different types or categories of components and/or different types of plastics or plastics with different characteristics. For instance, all or a portion of the system and/or method 10, such as shown at blocks 14, 16, 18, 20 and 22, may be performed using a collected group of used plastic components having the same or similar component types or categories and/or plastic of the same type or similar characteristics. On the other hand, all or a portion of the system and/or method 10 may include a first group of used plastic components (which may share a first component type or category and/or a first shared plastic type or category) and a second group of used plastic components (which may share a second component type or category and/or a second shared plastic type or category). If desired, the first group and the second group may be sized, mixed and/or combined to create, for example, a desired ratio. This may allow finished products with desired characteristics to be created. For example, used plastic components constructed with low-density polyethylene may be combined with used plastic components constructed from high-density polyethylene to create a finished product with desired characteristics.

Advantageously, as discussed above, the system and/or method 10 may allow used plastic components to be used to directly create finished plastic products. For example, a large discount retailer may collect hundreds or thousands of pounds of used plastic components during the normal course of business. These used plastic components may include shrink wrap, stretch wrap, packing materials, packaging materials, hangers, etc. The used plastic components may be collected at the location of the retailer and transported to a single location where the system and/or method is performed. As discussed above, the used plastic components may be cleaned, shredded, converted into moldable plastic, loaded into a mold and molded into a finished product. In addition, the used plastic components may be selected and/or sorted by the type of product or material so that the finished product has the desired properties and characteristics.

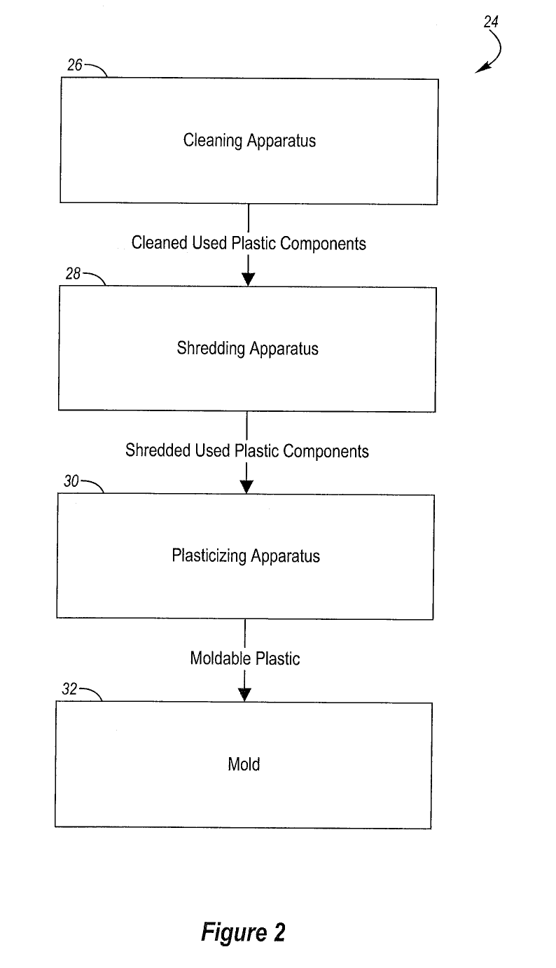

As shown in FIG. 2, another exemplary system 24 may include a cleaning apparatus 26, a shredding apparatus 28, a plasticizing apparatus 30 and/or a mold 32. The system 24 may be used to perform some or all of the steps described in connection with the system and/or method 10. It will be understood that these systems and methods do not require that each of the steps be performed or that the steps be performed in a particular order depending, for example, upon the particular type and/or characteristics of the finished product. It will also be understood that other steps or processes may be performed, if desired.

In further detail, the cleaning apparatus 26 may be sized and configured to clean the used plastic components, such as shown in block 14, and the shredding apparatus 28 may be sized and configured to shred the cleaned used plastic components, such as shown in block 16. Of course, as mentioned above, the used plastic components do not have to be cleaned or shredded. Thus the cleaning apparatus 26 or the shredding apparatus 28 are not required.

The plasticizing apparatus 30 may be configured to convert the used plastic components into moldable plastic, such as shown in block 18. The moldable plastic may be loaded from the plasticizing apparatus 30 into the mold 32, such as shown in block 20, and may be molded into a desired product, such as shown in block 22. If desired, the plasticizing apparatus 30 may be configured to load the plastic into the mold 32 by pouring, dropping and/or otherwise placing a charge of plastic directly into the mold.

In some instances, one or more other structures may be placed in the mold 32 with the moldable plastic. For example, fabric, carpet, in-mold graphics and/or other structures may be placed within the mold 32 to permit the moldable plastic to be molded with the structures. Thus, for instance, the mold 32 may be used to perform an overmolding or co-molding process, if desired.

Advantageously, the used plastic components may be molded into any desired finished products. For example, the plastic may be molded into finished products such as tables, chairs, basketball systems, enclosures, panels, partitions, fences and the like. Molding the plastic into finished products may advantageously help avoid the cost and material degradation that may occur from creating intermediate products. For example, intermediate products (such as pellets) may be molded into a shape and sized to facilitate shipping, storage and remolding of the plastic. Because the intermediate products are melted again and then molded a second time to create a finished product that may degrade the plastic and increase the cost of making the finished products. In addition, because the intermediate products are often shipped to other locations, that may increase the overall cost of making the finish products. Desirably, the systems and methods described above may be used to create finished products without any such intermediate products.

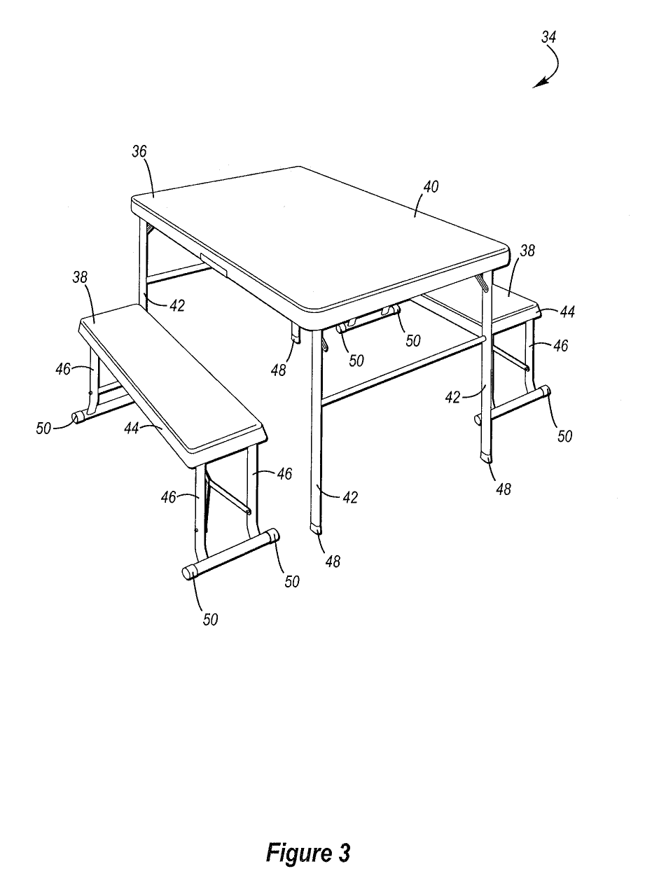

The systems and methods used to directly convert used plastic components to finished products may be used to create a variety of suitable structures and devices. For example, as shown in FIG. 3, an exemplary table and bench system 34 may be at least partially created using these systems and methods. As shown in the accompanying figures, the table and bench system 34 may include a table 36 and one or more benches 38. The table 36 may include a table top 40 and one or more legs or supports 42 connected to the table top. The benches 38 may include a bench top 44 and one or more legs or supports 46 connected to the bench top. The legs 42, 46 are preferably movable between a collapsed position and an extended position relative to the table top 12 and the bench top 44 respectively. The table 36 and benches 38 may also include one or more feet or end caps, such as feet or end caps 48, 50, which may be connected to or form part of the legs 42, 46.

Desirably, the table top 40, the bench tops 44, the feet or end caps 48, 50 and/or any other portion of the table and bench system 34 may be constructed from plastic using, for example, the system and/or method 10 and/or the system 24. Other suitable features of table and bench systems are disclosed in Assignee's U.S. patent application Ser. No. 10/916,823, which was filed on Aug. 12, 2004 and entitled FOLDING TABLE AND BENCH SYSTEM, the disclosure of which is incorporated by reference in its entirety.

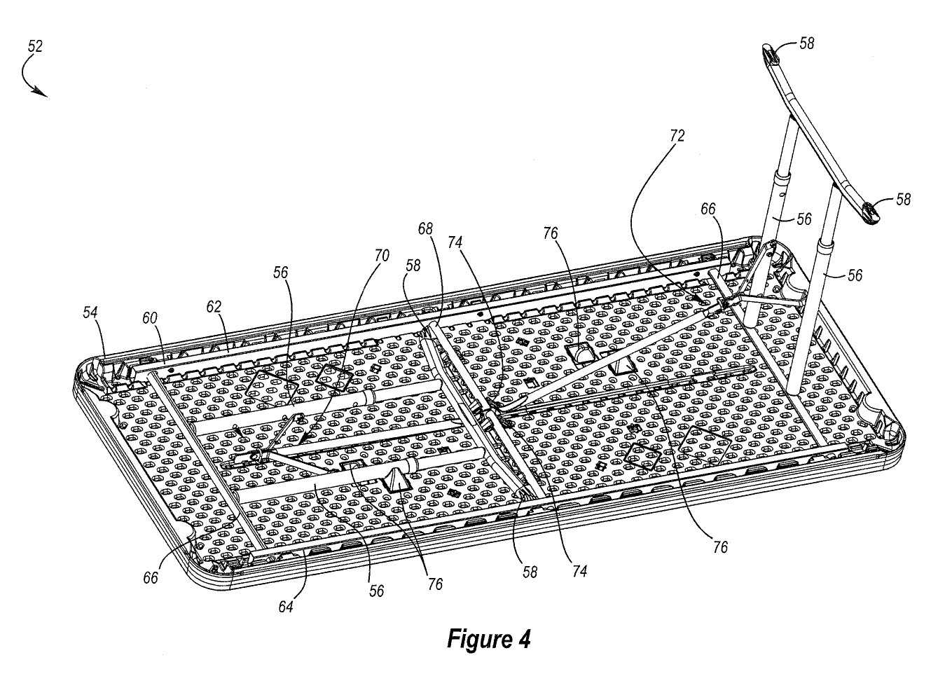

As shown in FIG. 4, an exemplary table 52 may include a table top 54 and one or more legs or supports 56. The legs 56 are preferably movable between a collapsed position and an extended position relative to the table top 54. The table 52 may also include one or more feet or end caps, such as feet or end caps 58, which may be connected to or form part of the legs 56.

The table 52 may also include a frame 60 which is connected to the table top 54. The frame 60 may be sized and configured to increase the strength and/or rigidity of the table top 54 or the frame may simply allow, for example, the legs 56 to be attached to the table top 54.

In further detail, the frame 60 may include one or more side rails 62, 64 and the table 52 may include one or more cross bars 66 that may be attached to the side rails. The cross bars 66 may rotate relative to the table top 54. In particular, the ends of the cross bars 66 may be inserted into openings in the side rails 62, 64 and this may allow the cross bars to rotate relative to the table top 54. The legs 56 may be attached to the cross bars 66, which may help facilitate movement of the legs between the extended and collapsed positions.

The table 52 may include one or more cross bars disposed proximate the center portion of the table top 54. For example, the table 52 may include a center cross bar 68 that is attached to the side rails 62, 64 of the frame 60 and it may rotate or be held in a generally fixed position relative to the table top 12.

The table 52 may also include braces 70, 72 that may be sized and configured to, for example, secure the legs 56 in the extended position. The braces 70, 72 may, for instance, be connected to the legs 56 and the center cross bar 68. If desired, the braces 70, 72 may be connected to the same center cross bar or different center cross bars.

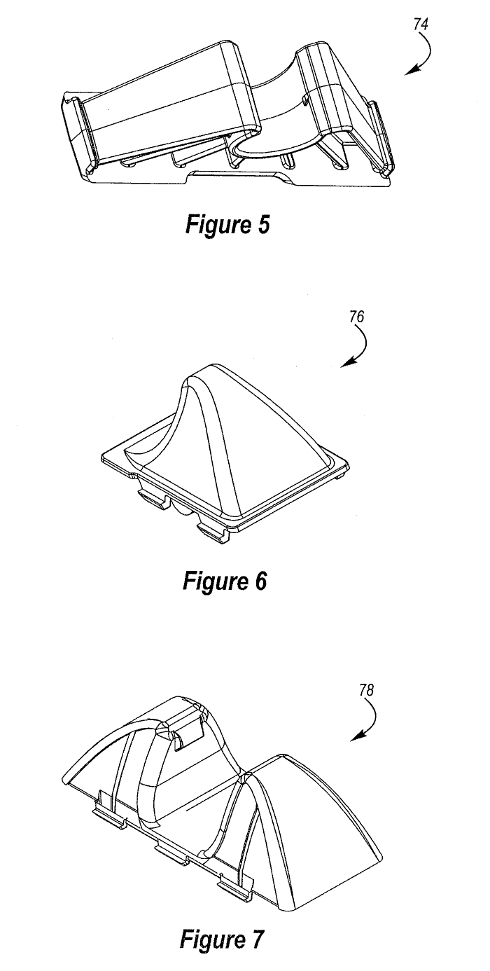

The table 52 may also include one or more receiving members, such as, mounting members 74 shown in FIGS. 4-5, securing members 76 shown in FIGS. 4 and 6 or the securing member 78 shown in FIG. 7. The receiving members may be connected to the table top 54 using a snap fit, a friction fit and/or an interference fit; one or more fasteners; one or more adhesives and/or any other suitable means.

Desirably, the receiving members may be sized and configured to receive and/or retain one or more portions of the table 52 using, for example, a snap fit, a friction fit and/or an interference fit. For instance, the mounting members 74 may receive and/or retain a portion of the center cross bar 68, and the securing members 76, 78 may receive and/or retain a portion of a leg (such as a leg 56) when in a collapsed position.

Desirably, the table top 54, the feet or end caps 58, the mounting members 74, the securing members 76, 78 and/or any other portion of the table 52 may be constructed from plastic using, for example, the system and/or method 10 and/or the system 24. Other suitable features of tables are disclosed in Assignee's U.S. patent application Ser. No. 11/140,719, which was filed on May 31, 2005 and entitled TABLE WITH RECEIVING MEMBERS, the disclosure of which is incorporated by reference in its entirety.

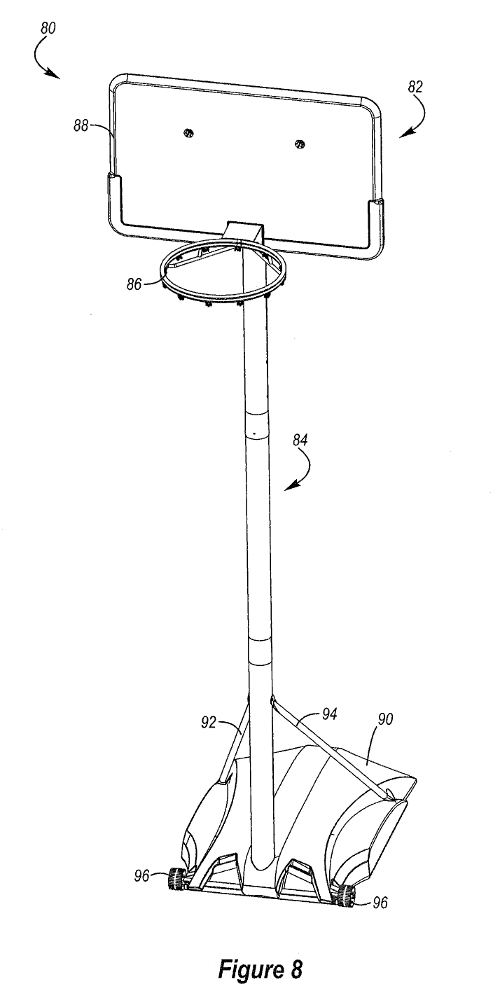

As shown in FIG. 8, an exemplary basketball system 80 may include a basketball goal 82 and a support structure 84 sized and configured to support the basketball goal at a desired height. The basketball goal 82 may include a rim 86, a backboard 88 and also a net. The basketball system 80 may also include a base 90 and the support structure 84 may be connected to the base. One or more weights may be placed on top of the base 90 to help stabilize the basketball system 80. In addition, the base 90 may include a hollow interior portion sized and configured to receive ballast, such as sand or water, to help stabilize the basketball system. The basketball system 80 may also include one or more braces 92, 94, which may be connected to the base 90 and the support structure 84. The basketball system 80 may also include one or more wheels 96, which may facilitate movement of the basketball system.

Desirably, the backboard 88, the base 90, the wheels 96 and/or any other portion of the basketball system 80 may be constructed from plastic using, for example, the system and/or method 10 and/or the system 24. Other suitable features of basketball systems are disclosed in Assignee's U.S. patent application Ser. No. 11/682,247, which was filed on Mar. 5, 2007 and entitled BASKETBALL SYSTEM, the disclosure of which is incorporated by reference in its entirety.

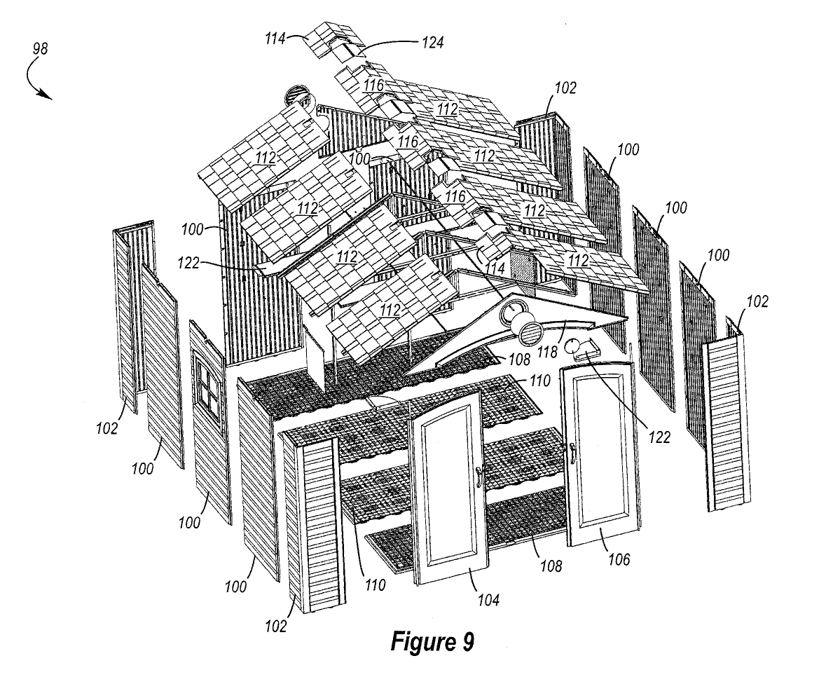

As shown in FIG. 9, an enclosure 98 may include one or more wall panels 100; corner panels 102; door panels 104, 106; floor panels 108, 110; roof panels 112; roof caps portions 114, 116; gables 118; shelves 120, 122 and skylights 124, which may be interconnected to form the enclosure. Desirably, the wall panels 100; the corner panels 102; the door panels 104, 106; the floor panels 108, 110; the roof panels 112; the roof cap portions 114, 116; the gables 118, the shelves 120, 122, the skylights 124 and/or any other portion of the enclosure 98 may be constructed from plastic using, for example, the method 10 and/or the system 24. Other suitable features of enclosures are disclosed in Assignee's U.S. patent application Ser. No. 11/432,825, which was filed on May 11, 2006 and entitled MODULAR ENCLOSURE, the disclosure of which is incorporated by reference in its entirety.

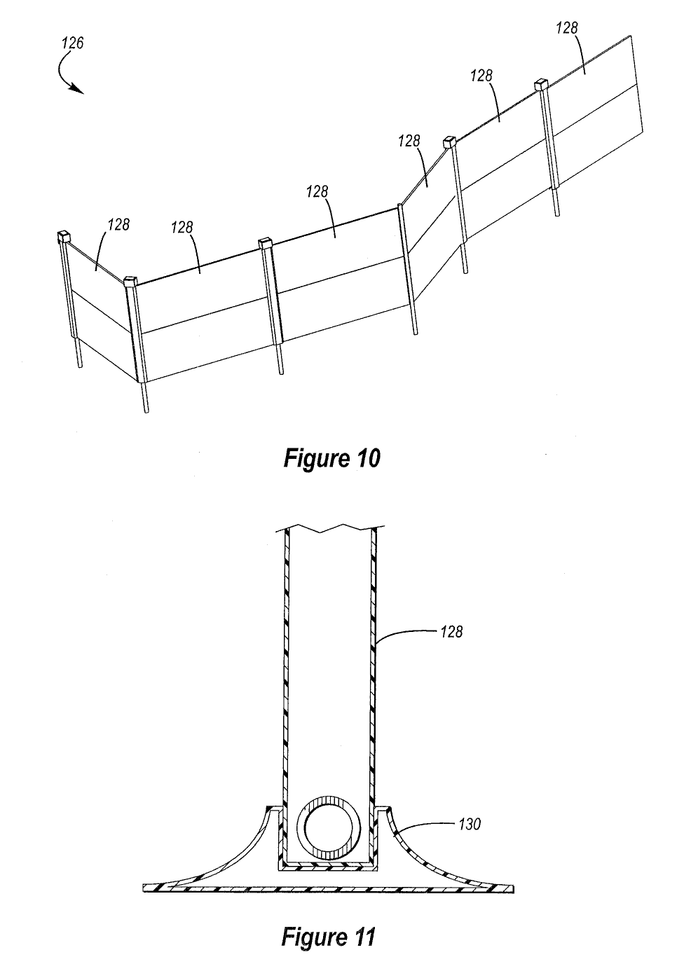

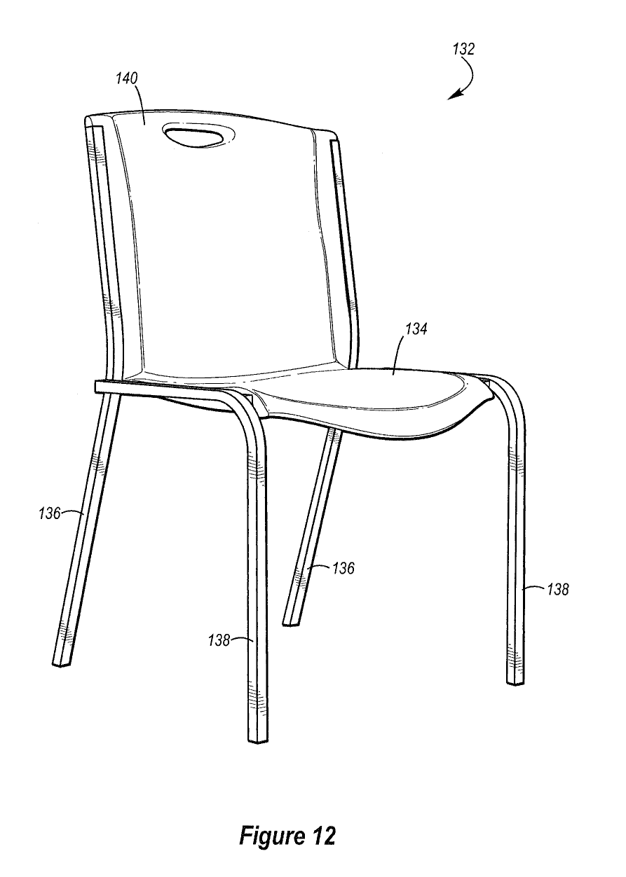

As shown in FIG. 10, an exemplary fence 126 may include one or more fence panels 128. As shown in FIG. 11, a mow strip 130 may be disposed proximate a a portion of a fence, such as a fence panel 128, to help hinder the growth of grass and/or other plants proximate the fence. Desirably, the fence panels 128, the mow strip 130 and/or any other portion of the fence 126 may be constructed from plastic using, for example, the system and/or method 10 and/or the system 24. Other suitable features of fences and/or mow strips are disclosed in Assignee's U.S. patent application Ser. No. 11/228,052, which was filed on Sep. 15, 2005 and entitled FENCE; and Assignee's U.S. provisional patent application Ser. No. 60/883,141, which was filed on Jan. 2, 2007 and entitled FENCE; the disclosures of each of these applications are incorporated by reference in their entireties.

As shown in FIG. 12, an exemplary chair 132 may include a seat 134 and one or more legs, such as rear legs 136 and front legs 138, that may be connected to the seat. The chair 132 may also include a backrest 140, which may be connected to the seat 134, the rear legs 136 and/or any other suitable portion of the chair 132. The chair 132 may also include additional features, such as armrests. The chair 132 may be configured to be a folding chair, a non-folding chair and/or other chairs having other suitable configurations.

Desirably, the seat 134, the backrest 140, the armrests and/or any other portion of the chair 132 may be constructed from plastic using, for example, the system and/or method 10 and/or the system 24. Other suitable features of chairs are disclosed in Assignee's U.S. patent application Ser. No. 10/980,950, which was filed on Nov. 3, 2004 and entitled CHAIR; and Assignee's U.S. patent application Ser. No. 11/030,427, which was filed on Jan. 6, 2005 and entitled PORTABLE FOLDING CHAIR, now U.S. Pat. No. 7,104,261; the disclosures of each of these applications are incorporated by reference in their entireties.

As shown above, various exemplary products and components may be constructed from plastic using, for example, the systems and/or methods 10, 24. It will be appreciated, however, that these exemplary products and components are merely used for illustration and that any other desired products and components may be constructed using the systems and/or methods 10, 24. Other such products and components may include, but are not limited to, automobile door panels, synthetic boards for outdoor decks and the like.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A method comprising:
converting plastic wrap into moldable plastic;
placing at least a portion of the moldable plastic into a compression mold; and
molding at least a portion of the moldable plastic placed in the compression mold into a product.

2. The method as in claim 1, wherein the placing at least a portion of the moldable plastic into a compression mold comprises:
dropping at least a portion of the moldable plastic into a compression mold.

3. The method as in claim 1, wherein the placing at least a portion of the moldable plastic into a compression mold comprises:
pouring at least a portion of the moldable plastic into a compression mold.

4. The method as in claim 1, wherein the plastic wrap comprises cleaned plastic wrap.

5. The method as in claim 1, wherein the plastic wrap comprises shredded plastic wrap.

6. The method as in claim 1, wherein the plastic wrap comprises cleaned and shredded plastic wrap.

7. The method as in claim 1, wherein the plastic wrap is constructed from polyethylene.

8. The method as in claim 1, wherein the product forms at least a portion of one or more of the following: a table, a bench, a basketball system, an enclosure, a fence, a mow strip and a chair.

9. A method comprising:
converting plastic wrap into moldable plastic;
placing at least a portion of the moldable plastic into an injection mold; and
molding at least a portion of the moldable plastic placed in the injection mold into a product.

10. The method as in claim 9, wherein the plastic wrap comprises cleaned plastic wrap.

11. The method as in claim 9, wherein the plastic wrap comprises shredded plastic wrap.

12. The method as in claim 9, wherein the plastic wrap comprises cleaned and shredded plastic wrap.

13. The method as in claim 9, wherein the plastic wrap is constructed from polyethylene.

14. The method as in claim 9, wherein the product forms at least a portion of one or more of the following: a table, a bench, a basketball system, an enclosure, a fence, a mow strip and a chair.
